(19) United States
(12) Patent Application Publication
(10) Pub. No.: US 2017/0366711 A1
(43) Pub. Date: Dec. 21, 2017

(54) NOZZLE-MOUNTED CAMERA SYSTEM AND METHOD

(71) Applicant: Envirosight LLC, Randolph, NJ (US)

(72) Inventor: Peter Kessler, Hirschegg (AT)

(21) Appl. No.: 15/693,840

(22) Filed: Sep. 1, 2017

Related U.S. Application Data
(63) Continuation of application No. 14/196,206, filed on Mar. 4, 2014.
(60) Provisional application No. 61/771,652, filed on Mar. 1, 2013.

(51) Int. Cl. H04N 5/225; E03F 7/12

(52) U.S. Cl. CPC H04N 5/2252; E03F 7/12

(57) ABSTRACT

A spray nozzle with a camera comprising: (a)a nozzle having an adapter for attaching a hose and one or more jets; and (b) a camera operatively connected to said nozzle, said camera comprising at least: (i) a water-proof housing having a transparent window on one end of said housing, said housing being configured for attachment to said nozzle; (ii) an imaging device in said housing with a field of view through said window; (iii) one or more lamps to illuminate at least a portion of said field of view; and (iv) a memory device operatively connected to said imaging device.

### RELATED APPLICATIONS

This application is a continuation of U.S. application Ser. No. 14/196,206, tiled on Mar. 4, 2014, which claims priority to U.S. Provisional Application No. 61/771,652, filed Mar. 1, 2013, all of which are hereby incorporated by reference in its entirety,

### FIELD OF INVENTION

The present invention relates to a camera system for imaging the inside of pipes, and, more specifically, to a nozzle-mounted camera for inspecting municipal pipes.

### BACKGROUND

Most municipalities contain a vast network of storm and sewer pipes, often representing the oldest infrastructure in the community. Periodically, these pipes must be inspected for problems such as cracks, blockage, build-up, and root infiltration. To this end, it is common for a device such as a pipe crawler or push camera to be introduced into the pipe to perform the inspection. Although effective in obtaining detailed images, using a pipe crawler is inconvenient and requires a great deal of time to set up and operate even if no problem is discovered. Furthermore, the use of pipe crawlers is frequently limited by the size and configuration of pipes to be entered. In this regard, often the condition of the pipe (e.g., debris and fractures) prevents the use of inspection devices like crawlers.

The inefficiencies associated with routine inspections are exacerbated in situations where the pipes need to he cleaned since pipe inspection and cleaning are typically performed by different personnel, often at different times, in a typical cleaning operation, an inspection is performed initially to determine whether the pipes are blocked. Such an inspection tends to he excessive since blockage conditions can be determined usually without the precision required for assessing cracks and other pipe damage. If a blockage is detected, then cleaning personnel must be brought in to perform an invasive cleaning operation. Once the cleaning procedure is performed, a second inspection is typically required to ensure that the blockage has been removed. This second inspection requires the inspection personnel to return and perform yet another invasive inspection (which as mentioned above is excessive in the first instance) to confirm whether the blockage has been removed. If the cleaning was not sufficient, then the cleaning personnel must return to continue the cleaning operation, and the cleaning/inspection process is repeated yet again. Thus, in this cleaning process, an inconvenient and excessive inspection is repeated between each cleaning causing delays and driving up costs.

Therefore, there is a need for a more convenient approach to inspect and maintain underground pipes without the time and complexity associated with specialized inspection techniques inherent in the use of pipe crawlers or push cameras. The present invention fulfills this need among others,

### SUMMARY OF INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention provides for a quick and convenient approach to ascertain the condition of the pipe before, during or after its cleaning. Specifically, the present invention relates to a camera that is adapted for connection to a conventional nozzle used for cleaning sewers. Such nozzles are well known. A typical nozzle has jets such that, when the nozzle is attached to a water hose and the hose is pressured, the water is expelled through the jets to propel the nozzle down a pipe, thus cleaning the pipe as the nozzle is propelled down the pipe. Applicant recognizes that these nozzles may be used to convey a camera down a pipe with very little adaptation of the nozzle or training of the crews that operate the nozzle. Rather, conventional nozzles may be used by typical cleaning crews to both clean and inspect the pipes.

The inspection may be performed by the crew before cleaning, during the cleaning process or after cleaning to ensure the cleaning job is complete. Once the images are obtained, an analysis may be performed to determine whether problems such as cracks, blockage, and root infiltration exist. The images obtained preferably are in a readily-transmitted form, such as digital video or still images of any know format. If no problem is detected, then the system can he moved quickly to another area to perform another inspection. This way, the time of setting up and operating a pipe crawler or similar device is not wasted on areas that are in acceptable condition. On the other hand, if a problem is detected, a cleaning procedure may be performed right then. For example, if a crack is detected, a more comprehensive inspection may be performed in which an invasive inspection device, such as a pipe crawler or push camera, is introduced in the pipe to obtain detailed images pursuant to formulating a plan to remedy the situation. Likewise, if the initial inspection detects that a pipe is clogged, it may he cleaned contemporaneously by introducing a cleaning nozzle or other invasive cleaning device into the pipe to remove the obstruction. Once the cleaning procedure is completed, the nozzle-mounted camera system may be used again to ensure that the cleaning is adequate. Thus, rather than awkwardly halting cleaning operations between inspections and involving different cleaning and inspection crews, an inspection may be performed quickly and easily on the spot by the cleaning crew.

Applicant also recognizes that simplifying the operation of the camera is preferred not only because cleaning crews tend to lack training for more-complex video inspection techniques, but also because the environment is particularly harsh in the pipe. Thus, a simple, reliable way of recording images of the pipe is generally preferred over more complex, sophisticated techniques. Accordingly, in one embodiment, the camera is self-contained, in which no remote communications, control, or power is required for it to operate. It is simply turned on, sent down the pipe to record images, and then retrieved to recover the recorded messages. Applicant has determined that such simplicity avoids problems inherent in cable and wireless communications and remote power supply.

Accordingly, one aspect of the invention is a camera for attaching to a nozzle for pipe inspection. In one embodiment, the camera comprises: (a) a water-proof housing having a transparent window on one end of the housing, the housing being configured for attachment to the nozzle; (b) an imaging device in the housing with a field of view through the window; (c) one or more lamps to illuminate at least a portion of the field of view; and (d) a memory device operatively connected to the imaging device. In one embodiment, the camera is self-contained with the power (e.g., battery) and control necessary to image and record the inside of a pipe. In this embodiment, the operating does not control the system once it is turned on and positioned in a pipe.

Another aspect of the invention is a nozzle-mounted camera system for inspecting pipes. In one embodiment, nozzle-mounted camera system comprises: (a) a nozzle having an adapter for attaching a hose and one or more jets; and (b) a camera operatively connected to the nozzle, the camera comprising at least: (i) a water-proof housing having a transparent window on one end of the housing, the housing being configured for attachment to the nozzle; (ii) an imaging device in the housing with a field of view through the window; (iii) one or more lamps to illuminate at least a portion of the field of view; and (iv) a memory device operatively connected to the imaging device. As mentioned above, in one embodiment, the camera is self-contained with the power (e.g., battery) and control necessary to image and record the inside of a pipe.

Yet another aspect of the invention is a method of using a nozzle mounted camera to inspect a pipe. In one embodiment, the method of imaging a pipe comprises the steps of: (a) attaching a hose to a nozzle, the nozzle having one or more jets and having a camera operatively connected thereto, the camera having memory for recording images; (b) activating the camera to record images in the memory; (c) after step (a), positioning the nozzle in a pipe; (d) causing a fluid to flow through the hose into the nozzle under pressure such that the fluid is expelled through the jets to propel the nozzle down the pipe; and (e) after the nozzle travels down a length of the pipe, obtaining recorded images from the memory.

### BRIEF DESCRIPTION OF DRAWINGS

FIG. 1 shows one embodiment of the nozzle-mounted camera system of the present invention.

FIG. 2 shows a perspective view of the camera from the system of FIG. 1.

FIG. 3 shows a rear view of the system of FIG. 1,

FIG. 4 shows the system of FIG. 1 being propelled down a pipe.

FIG. 5 shows the back of the camera of FIG. 2 with a cap of the portal removed.

### DETAILED DESCRIPTION

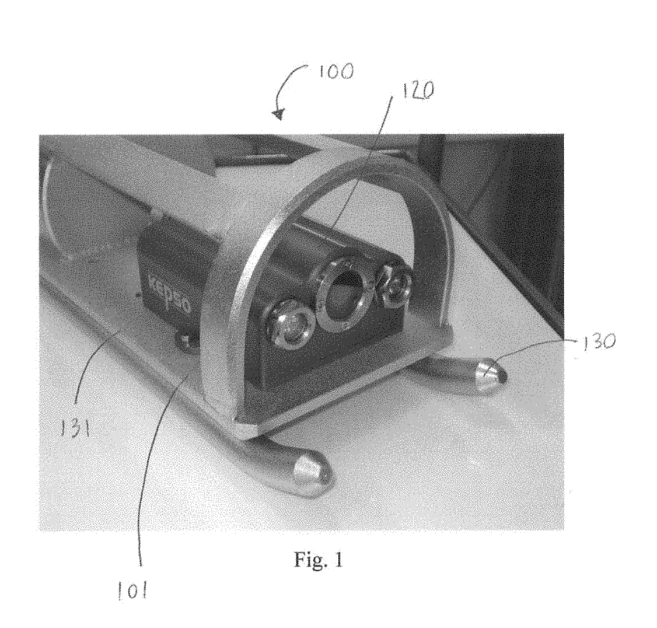

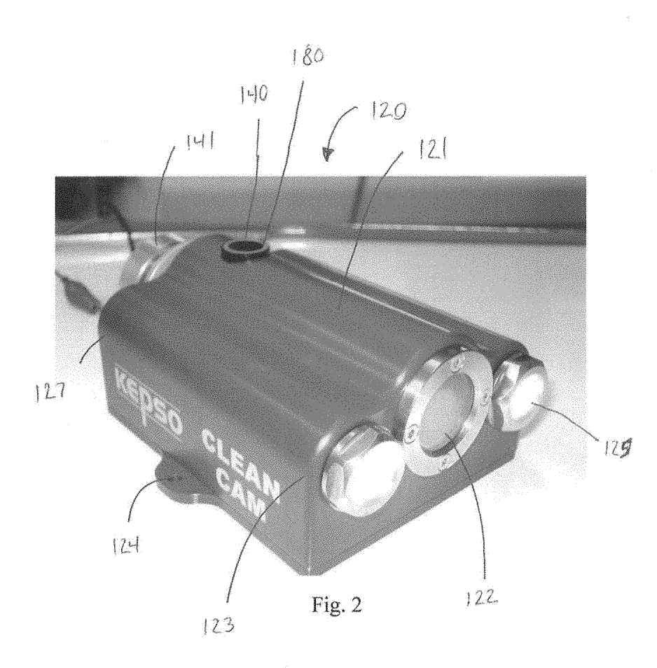

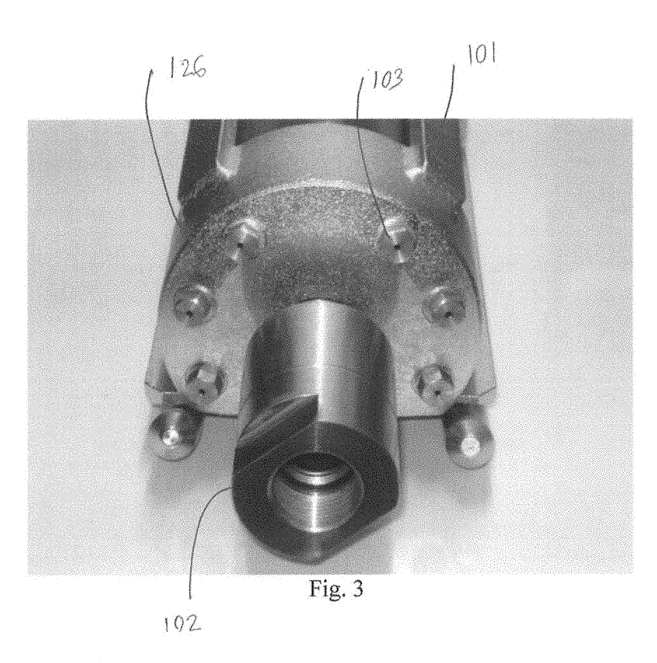

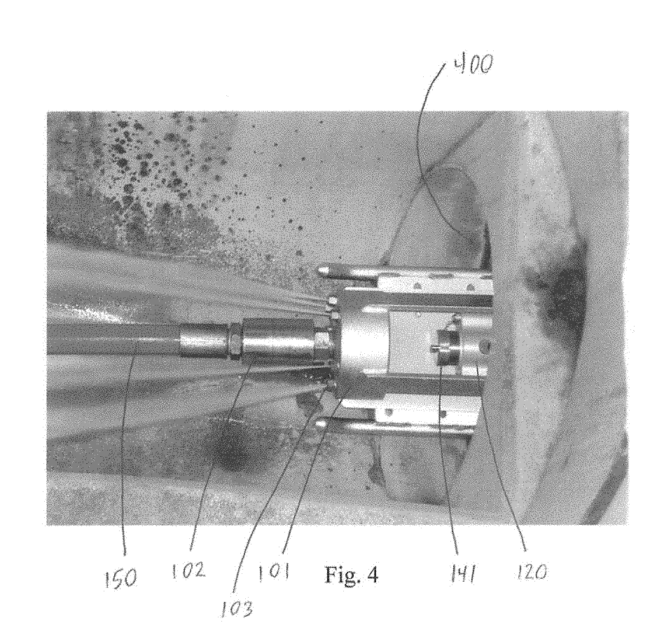

Referring to FIGS. 1-4 a preferred embodiment of a nozzle-mounted camera system 100 is shown. The system 100 comprises a nozzle 10 having an adapter 102 (see FIG. 2) for attaching a hose 150 (see FIG. 4) and one or more, jets 103; and a camera 120 operatively connected to the nozzle 101. The camera 120 comprises at least a water-proof housing 121 having a transparent window 122 on one end 123 of the housing, the housing 121 being configured for attachment to the nozzle (e.g., bolt holes 124); an imaging device in the housing (not shown) with a field of view through the window; one or more lamps 125 to illuminate at least a portion of the field of view; and a memory device (not shown) operatively connected to the imaging device.

The nozzle-mounted camera system 100 is particularly well suited for inspecting the interior of pipes such as sewer and storm pipes 400 (see FIG. 4). In one embodiment, the method comprises the steps of: (a) attaching a hose 150 to a nozzle 101, the nozzle having one or more jets 103 and having a camera 120 operatively connected thereto, the camera having memory for recording images; (b) activating the camera to record images in the memory; (c) positioning the nozzle in a pipe (see FIG. 4); (d) after step (b) causing a fluid to flow through the hose into the nozzle under pressure such that the fluid is expelled through the jets 103 to propel the nozzle down the pipe (see FIG. 4); and (e) after the nozzle travels down a length of the pipe, obtaining recorded images from the memory. Once the recorded images are retrieved they may be viewed on any known display device including, for example, a tablet, smart phone, computer or specifically designed display unit configured to receive and process the electronic memory files.

Details of the product features and method steps are discussed in greater detail below.

Referring to FIG. 1, a nozzle 101 is shown for conveying the camera 120 down a pipe by virtue of pressurized water being expelled from the jets 103 of the nozzle 101. Such nozzles are well known in the industry, but are used conventionally for cleaning the pipe, and not for conveying the camera down the pipe as disclosed herein. Indeed, one advantage of the present invention is that conventional nozzles can be adapted readily to carry the camera 120 of the present invention. Typically, a nozzle comprises a body 131 to support the jets 103 and adapter 102, and a sled, wheels, or rails 130 (as shown) to facilitate the nozzles movement down the pipe. The back end 126 of the nozzle comprises the adapter 102 for connection to a hose, and jets 103 as described above. The adapter 102 can be any commercially-available hose coupling or similar device. Likewise, the hose 150 may be any commercially-available hose used in the pipe cleaning industry. Although it is generally preferred to pressurize the hose with water and expel the water through the jets 103 to propel the nozzle 101 down the pipe (as shown in FIG. 4), other embodiments are possible. For example, rather than water, the hose can be pressurized with air such that air propels the nozzle down the pipe.

Although conventional nozzles may be used to practice the present invention, it should he understood that applicant anticipates nozzles being optimized for carrying camera systems. For example, such nozzles may be optimized to minimize lateral spray which may interfere with the imaging process. In this respect, the jets 103 can be configured to direct the spray of water axially and thus propel the nozzle more efficiently. Still other enhancements and optimizations of the nozzle 101 will be obvious to those of skill in the art in light of this disclosure.

Referring to FIG. 2, a perspective view of the camera 120 is shown. The camera comprises a housing 121, which serves to protect the internal components of the camera 120. (The internal components may include, for example, the imaging device, power supply, lamps, and memory device.) Because the camera 120 will be used in sewers and storm drains which may be partially or fully filled with water or other liquid, and because the propulsion system of the nozzle is usually water, it is generally preferred, although not necessary, that the housing 121 be waterproof to protect the internal components.

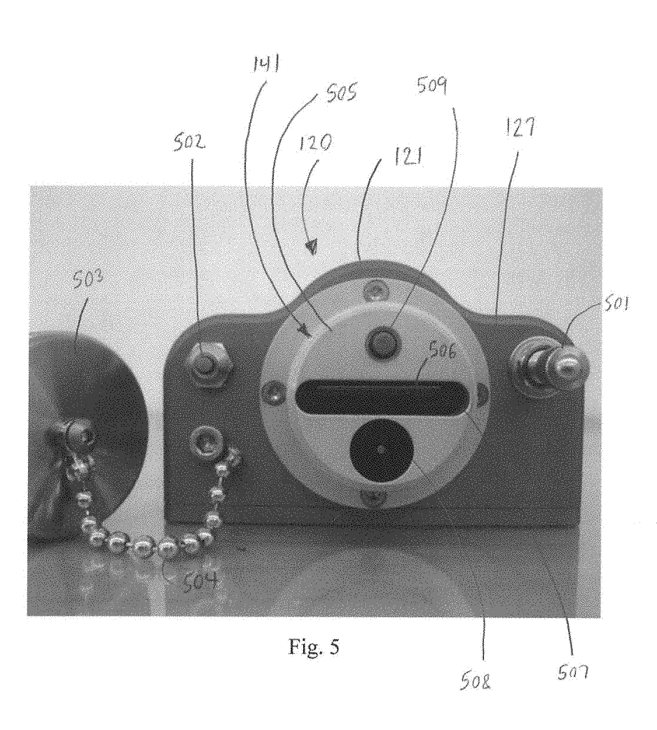

In one embodiment, in addition to being waterproof, the housing is also configured to be pressurized. Pressurizing the housing ensures that liquid and other debris does not enter the housing and compromise the internal components. The housing can be pressurized with any conveniently-obtained, non-flammable gas such as, for example, air or nitrogen. Generally, nitrogen is preferred. In one embodiment, the rear end 127 of the housing 121 as shown in FIG. 5 comprises a common valve 501 for interengaging with a pressurized source of gas to pressurize the housing. In one embodiment, the hosing also comprises a visual indication of proper pressurization. Specifically, in one embodiment, a pressure indicator 502 is provided on the rear end 127 of the housing 121. In this embodiment, the pressure indicator is a simple button which protrudes when the internal pressure is sufficient and retracts when it is insufficient. Such a simple configuration provides an immediate indication to the user of whether the pressure within the housing 121 is adequate.

The housing also provides a transparent window 122 through which the imaging device records images of the interior of the pipe as the nozzle travels down the pipe. In one embodiment, the camera 120 also comprises lamps 125 to illuminate the field of view of the imaging device. Suitable lamps include, for example, LED, halogen and high intensity discharge lamps. Such lamps are well known and commercially available. Generally, LED lamps are preferred because of their low power consumption.

The camera 120 also comprises an imaging device within the housing 121. The imaging device may be any known, commercially-available imaging device. In one embodiment, the camera has a wide filed of view. In one particular embodiment, the viewing angle is about 130 degrees diagonal, with a VGA resolution of about 640×480 pixels. In one embodiment, the imaging device is configured to record in AVI-files format. It should be understood however that imaging device with varying viewing angles, resolutions and recording formats can be practiced with the invention. For example, the images recorded may be video images or still images or a combination of the two.

The camera 120 also comprises a memory device to record the images of the imaging device. The memory device can be any commercially-available, non-volatile memory storage system. Such systems are well known. In a specific embodiment, the memory device comprises electronic flash memory data storage device(s) such as those used in many electronic devices, including digital cameras, mobile phones, laptop computers, and video game consoles. At this time, secure digital (SD) drives have been used with acceptable results, although it is expected that memory devices will continue to evolve and that the invention may he practiced with later-developed memory devices. Generally, it is preferred that there be enough storage on the device to handle one or more inspections. Suitable memory sizes can be determined by one that is skilled in the art in light of this disclosure without undue experimentation. For example, in one embodiment, recording consumes about 4 gigabytes per hour. Accordingly, the memory device should be sized to accommodate the expected memory consumption, in one particular embodiment, the memory device comprises a 32 GB SDHC. Generally, it is preferred to have a solid state memory device as such devices tend to be more durable, although suitable rugged disk drives can also be used. Furthermore, although removable memory is considered in detail herein, it should be understood that the memory may he fixed and that the camera 120 may have a data interface to transfer data from the memory device to another device. This data transfer interference may be over a cable or it may be wireless. Such interfaces are well known and commercially available.

In one embodiment, the camera system 120 is powered by batteries contained within the housing 121. Such an approach is advantageous in that such batteries are well known and commercially available, and, allow the camera 121 to be a totally self-sufficient image recording unit. It should also be noted that the battery in this context is used broadly to refer to any traditional battery or fuel cell power approach. Although batteries are generally preferred to power the camera 120, it should be understood that other means of powering the camera 120 are within the scope of the claims. For example, in one embodiment, power is provided remotely and is connected to the camera 120 through a conventional power cord.

In one embodiment, the electrical interface to the camera 120 is provided in a portal 141. As shown in the embodiment of FIG. 5, the portal 141 comprises a protrusion 505 and a cap 503 which is threadably engageble with the protrusion 505 to form a waterproof seal. For convenience, the cap 503 is connected to the housing 121 with a chain 504. In this particular embodiment, the portal 141 comprises and access slot 507 to the memory device 506 (which, in this embodiment, is an SD card), a battery charger interface 508 for charging the batteries of the device, and a main switch 509. Although the portal 141 is depicted with the main switch 509, battery interface 508 and memory access 507, other embodiments are possible and would be obvious in light of this disclosure. For example, the portal may comprise additional instrumentation to show, for example, battery charge level, remaining memory space, and other features that are known and would be obvious in light of this disclosure,

In one embodiment, the camera 120 provides convenient access points to operate the device. For example, in one embodiment, the housing comprises a start/stop button 140 conveniently located on the top of the housing. The start/stop button can be configured in different ways. For example, in one embodiment, the button starts and stops the system with no other controls required, and, in another embodiment, the button 140 works in conjunction with an other switch (see, e.g., the main switch 509, see FIG. 5) to activate a more specific function, for example, recording images.

In one embodiment, the camera 120 also comprises a light 180 (e.g., LED) to indicate the functional status of the camera. For example, the light 180 can be configured to flash at different frequencies, or display different colors, or stay on or off depending on different conditions. For example, in one embodiment, the light 180 can provide an indication of when the memory device is full, or missing, or otherwise not functioning properly. In this embodiment, the light may not flash or it may flash quickly if a problem with the memory is detected. Likewise, in another embodiment, the light 180 may flash in a different pattern or change color to indicate low battery status. Still other signaling by the light 180 will be obvious to those of skill in the art in light of this disclosure.

It is generally preferred although not necessary that the operation of the camera 120 be as simple and require little input from the user. In this respect, the device has just a few control features and simple on/off switches as described above. Thus, the user simply connects the camera to the nozzle 101, turns the camera 120 on, places the camera in a sewer or storm pipe through a manhole as shown in FIG. 4, pressurizes the hose such that the water is expelled through the jets 103 to push the camera and nozzle down the pipe, and, when completed, retrieves the camera 120 and the images stored in the memory device.

More specifically, in one embodiment, the user charges the battery through the battery interface 502 until the battery is fully charged. Next, the operator checks to determine if the pressure indicator 502 is indicating that the pressure is sufficient within the housing. As mentioned above, in one embodiment, this would simply be a matter of observing whether the indicator 502 is sticking out. If the pressure indicator switch is not sticking out, then the housing must be pressurized until it does. Next, if not already done, the memory device 506 is inserted through the access port 507 in the portal 141. Once the memory device is installed through the access port, the cap 503 is screwed onto the protrusion 505 tightly. In one embodiment, the device is placed in stand-by mode by actuating the main switch 509 before screwing the cap on. In this embodiment, the main switch powers the imaging device, the lamps, and the memory device, but does not yet activate the imaging device to start recording images/video. Once the cap 503 is screwed in place, in one embodiment, the light 180 around the on/off switch 140 begins to flash. In one embodiment, the light 180 provides an indication of when the memory device is full, or missing, or otherwise not functioning properly. To start the recording process, the on/off switch 140 is depressed. At this point, the images from the imaging device are recorded by the memory device and the light 180 stays on. To stop the images from being recorded, the on/off switch 140 is simply pressed again. The memory device then can be retrieved from the portal 141 of the camera. In one embodiment, the memory card is ejected from the unit and the recorded images are reviewed on any SDHC-compatible device.

While this description is made with reference to exemplary embodiments, it will be understood by those skilled in the art that various changes may be made and equivalents may be substituted for elements thereof without departing from the scope in addition, many modifications may be made to adapt a particular situation or material to the teachings hereof without departing from the essential scope. Also, in the drawings and the description, there have been disclosed exemplary embodiments and, although specific terms may have been employed, they are unless otherwise stated used in a generic and descriptive sense only and not for purposes of limitation, the scope of the claims therefore not being so limited. Moreover, one skilled in the art will appreciate that certain steps of the methods discussed herein may be sequenced in alternative order or steps may be combined. Therefore, it is intended that the appended claims not he limited to the particular embodiment disclosed herein.

What is claimed is:

1. A method of imaging a pipe, said method comprising the steps of:
(a) attaching a hose to a nozzle, said nozzle having one or more jets and having a camera operatively connected thereto, said camera having memory for recording images;
(b) activating said camera to record images in said memory;
(c) positioning said nozzle in a pipe;
(d) after step (a), causing a fluid to flow through said host into said nozzle under pressure such that said fluid is expelled through said jets to propel said nozzle down said pipe; and
(e) after said nozzle travels down a length of said pipe, obtaining recorded images from said memory

2. The method of claim 1, wherein step (e) comprises removing a memory device from said camera.

3. The method of claim 2, wherein, in step (e) said memory device is accessed from outside of said housing.

4. The method of claim 3, wherein, in step (e) said memory device is accessed by removing a water-tight cap from a protrusion extending from said housing.

5. The method of claim 2, wherein said memory device is an SD-Card.

6. The method of claim 1, wherein step (e) comprises transmitting said recorded images from said memory to a second memory.

7. The method of claim 1, wherein said step (b) comprises actuating an on\off switch to start said camera and begin recording images on said memory device.

8. The method of claim 7, wherein said on/off switch is accessible from outside of said housing.

9. The method of claim 8, wherein said on/off switch is disposed on the top of said housing.

10. The method of claim 7, wherein said on/off switch comprises an LED to indicate when said camera is on and said memory device is recording images from said camera.

11. The method of claim 1, further comprising attaching a camera to said spray nozzle.

12. A camera configured for attachment to a spray nozzle, comprising:
a water-proof housing having a transparent window on one end of said housing, said housing being configured for attachment to said nozzle;
an imaging device in said housing with a field of view through said window;
one or more lamps to illuminate at least a portion of said field of view; and
a memory device operatively connected to said imaging device,

13. The camera of claim 12, wherein said memory device is accessible from outside of said housing.

14. The camera of claim 13, wherein said memory device is disposed on a protrusion adapted to be capped with a water-tight cap.

15. The camera of claim 12, wherein said memory device is an SD-Card.

16. The camera of claim 12, further comprising an on\off switch to start said camera and begin recording images on said memory device.

17. The camera of claim 16, wherein said on/off switch is accessible from outside of said housing.

18. The camera of claim 17, wherein said on/off switch is disposed on the top of said housing.

19. The camera of claim 16, wherein said on/off switch comprises an LED to indicate when said camera is on and said memory device is recording images from said camera.

20. A spray nozzle with a camera comprising:
a nozzle having an adapter for attaching a hose and one or more jets; and
a camera operatively connected to said nozzle, said camera comprising at least:
a water-proof housing having a transparent window on one end of said housing, said housing being configured for attachment to said nozzle;
an imaging device in said housing with a field of view through said window;
one or more lamps to illuminate at least a portion of said field of view; and
a memory device operatively connected to said imaging device.
